(19) United States
(12) Patent Application Publication
(10) Pub. No.: US 2008/0183457 A1
(43) Pub. Date: Jul. 31, 2008

(54) SIMULATION DISPLAY TOOL

(76) Inventors: Russell Klein, West Linn, OR (US); Marc Minato, West Linn, OR (US)

Correspondence Address: KLARQUIST SPARKMAN, LLP, 121 S.W. SALMON STREET, SUITE 1600, PORTLAND, OR, 97204, US

(21) Appl. No.: 11/852,652

(22) Filed: Sep. 10, 2007

Related U.S. Application Data
(60) Provisional application No. 60/898,784, filed on Jan. 31, 2007.

(51) Int. Cl. G06F 17/50

(52) U.S. Cl. 703/14

(57) ABSTRACT

A simulation of an execution of a software program in an electronic circuit design can be analyzed to determine values simulated as being stored, such as in the memory and registers of the design, including values that are not necessarily observable on the outputs of the design. In some embodiments, a user can indicate a time period in the simulation results, or a portion of the software executable. One or more values stored in the design can be determined according to the circuit design, a description of one or more transactions of values stored in the circuit design, and one or more indications of signals provided on the outputs of the design. This can allow a user to examine values simulated as being stored in the circuit design using, for example, a software debugger showing register and memory watches. The disclosed technologies can be used with various user interface elements.

### CROSS-REFERENCE TO RELATED APPLICATION

This application claims the benefit of U.S. Provisional Patent Application No. 60/898,784, filed Jan. 31, 2007, titled “SIMULATION DISPLAY TOOL”, which is incorporated herein by reference.

### FIELD

The disclosed technologies relate to displaying the results of a simulation of an electronic circuit design.

### BACKGROUND

Logic simulation tools are often used for analyzing an electronic circuit design. For example, a simulator can receive a description of inputs (e.g., commands, data values) to be applied to a description of the circuit design. Simulator outputs can be compared to expected values to determine if the circuit design is functioning properly. However, the outputs of a circuit design simulation (e.g., values simulated as appearing on one or more output pins of the simulated circuit design) often provide an incomplete picture of simulated operations taking place within the design. For example, a particular design can be configured to provide one or more register values to output pins, but values from a cache may be unavailable. Determining such values from simulation results, even if the architecture of the circuit design is known, can be a difficult and laborious task, particularly when there are a large number of results or when a simulation is relatively long.

### SUMMARY

Results of a simulation of a software executable in an electronic circuit design can be presented and used to determine values simulated as being stored, such as in the memory and registers of the design, including values that are not necessarily observable on the outputs of the design. In some embodiments, a user can indicate a time period in the simulation results, or a portion of the software executable. One or more values simulated as being stored in the design can be determined according to the circuit design, a description of one or more transactions of values stored in the circuit design, and one or more indications of signals provided on the outputs of the design. This can allow a user to examine values simulated as being stored in the circuit design using, for example, a software debugger showing register and memory watches.

In some embodiments, a method of displaying information about a simulation of an electronic circuit design, wherein the simulation simulates a software program being executed by the electronic circuit design and generates simulation results, comprises: displaying, as a first indicator, either information describing a simulated status of the software program in the electronic circuit design or the simulation results; determining, according to a data set describing a plurality of values simulated as being stored in the electronic circuit design during the simulation, a corresponding other of the information describing the simulated status of the software program in the electronic circuit design or the simulation results; and displaying, as a second indicator, the corresponding other of the information describing the simulated status of the software program in the electronic circuit design or the simulation results. In some embodiments the information describing the simulated status of the software program in the electronic circuit design is displayed by a software debugger application. In particular embodiments the information describing the simulated status of the software program in the electronic circuit design comprises one or more of the plurality of software instructions designed for execution on the electronic circuit design. Sometimes the first indicator denotes at least one of the software instructions shown in a listing of the software instructions in a software debugger application, wherein the second indicator denotes a portion of a waveform shown in a waveform viewer, and wherein the second indicator describes one or more values simulated as being stored in the circuit design at an approximate time when the at least one of the software instructions is simulated as being executed. In further embodiments the first indicator is displayed as a result of stepping, in the software debugger application, from a first portion of the software instructions to a second portion of the software instructions. In additional embodiments the information describing the simulated status of the software program in the electronic circuit design comprises one or more register values. Sometimes displaying the simulation results comprises displaying at least a portion of the simulation results as a waveform. In some embodiments the data set describes data simulated as being written to registers or memory addresses described in the electronic circuit design. The first and second indicators can be displayed simultaneously on one display. The status data for the software program can comprise, for example, software instructions (e.g., source code instructions, assembly code instructions and/or machine code instructions), register values, memory values, variable values, and/or other information that describes the state of a software executable as simulated in the electronic circuit design. In some embodiments the second indicator comprises cursor-responsive supplemental information, such as a tooltip.

In further embodiments determining the corresponding other of the information describing the simulated status of the software program in the electronic circuit design or the simulation results further comprises determining effects of one or more simulated write operations on register or memory addresses described in the circuit design. In additional embodiments determining the corresponding other of the information describing the simulated status of the software program in the electronic circuit design or the simulation results comprises reading data set data between a reference point and a point in the data set associated with the first indicator. Sometimes the reference point corresponds to a first point in time in the data set data, wherein the point in the data set data associated with the first indicator corresponds to a second point in time in the data set data, and wherein the first point in time is before the second point in time. Sometimes the reference point corresponds to a first point in time in the data set data, wherein the point in the data set data associated with the first indicator corresponds to a second point in time in the data set data, and wherein the first point in time is after the second point in time.

In particular embodiments a user interface for displaying information about a simulation of an electronic circuit design on a display comprises: a first display region displaying one or more software status data for a software program whose execution in the circuit design was at least partially simulated during the simulation; a second display region displaying the simulation results; a first cursor in a first position in the first display region indicating a first portion of the software status data; and a second cursor in a second position in the second display region that indicates a simulation result corresponding to the first portion of the software status data, wherein displaying the first cursor in a first alternate position indicating a second portion of the software status data results in displaying the second cursor in a second alternate position indicating a simulation result corresponding to the second portion of the software status data, or wherein displaying the second cursor in the second alternate position results in displaying the first cursor in the first alternate position. The software status data sometimes comprises one or more software instructions.

In some embodiments, a system for displaying simulation results of a simulation of an electronic design comprises: a first software component configured to display one or more status data for a software program executed as part of the simulation to produce the simulation results; a second software component for displaying at least a portion of the simulation results; a third software component configured to examine, in response to selecting either at least one of the status data for the software program or the at least a portion of the simulation results, a list of values simulated as being stored in the circuit design during the simulation; and a fourth software component configured to display, based on the examined list of values, the at least one of the status data for the software program if the at least a portion of the simulation results is selected, or to display, based on the examined list of values, the at least a portion of the simulation results if the at least one of the status data for the software program is selected. In some cases the first software component is a software debugger application and the second component is a waveform display application. In additional cases selecting either at least one of the status data for the software program or the at least a portion of the simulation results occurs in response to one or more of user input, a script, or a software debugger application. Some embodiments further comprise a fifth software component for generating the list of values. The status data for the software program comprises one or more software instructions.

In further embodiments a method of displaying results of a simulation of an electronic circuit design, the design being configured to store a first set of values that are provided on one or more output pins of the design and a second set of values that are not provided on the one or more output pins of the design, the simulation being of a software program being executed on the design, comprises: reading from one or more computer-readable media a description of a plurality of transactions simulated as occurring in the electronic circuit design during the simulation, the transactions affecting values in the first and second sets of values; determining, according to the electronic circuit design, the software program, and the description of a plurality of transactions, one or more values of the second set of values; and storing the one or more values of the second set of values in one or more computer-readable media. The method can further comprise generating the description of a plurality of transactions.

In additional embodiments, one or more computer-readable media can contain a data structure describing results of a simulation of an electronic circuit design, wherein the data structure can comprise: a time indicator for the simulation; a write address indicator identifying one or more data storage locations described in the circuit design; and a write value indicator identifying one or more values simulated as being written to the one or more storage locations in the circuit design. The data structure can further comprise an indication of one or more values simulated as being overwritten by at least some of the values simulated as being stored in the one or more storage locations. In further embodiments the data structure can further comprises a write type indicator. In additional embodiments the write type indicator can identify at least one of a register or a memory location.

In further embodiments, one or more computer-readable media contain instructions configured to cause a computer to execute one or more of the above methods and/or to provide a user interface as disclosed herein.

The foregoing features and aspects of the disclosed technologies will become more apparent from the following detailed description, which proceeds with reference to the accompanying figures.

### BRIEF DESCRIPTION OF THE DRAWINGS

FIG. 1 is a block diagram of an exemplary system for analyzing an electronic circuit design.

FIG. 2 is block diagram of an exemplary technique for displaying results of a simulation of an electronic circuit design.

FIG. 3 shows a portion of one exemplary embodiment of a data set.

FIG. 4 is a block diagram of one exemplary embodiment of a method for displaying circuit simulation results using a data set.

FIG. 5 shows exemplary embodiments of applications used for displaying simulation results of an electronic circuit design.

FIG. 6 is a block diagram of an exemplary computer network that can be used with technologies described herein.

FIG. 7 is a block diagram of an exemplary manner in which the network of FIG. 6 can be used to display results of a simulation of an electronic circuit design.

### DETAILED DESCRIPTION

Disclosed below are representative embodiments of methods, apparatus, and systems for displaying results of a simulation of an electronic circuit design that should not be construed as limiting in any way. Instead, the present disclosure is directed toward all novel and nonobvious features and aspects of the various disclosed methods, apparatus, and systems, alone and in various combinations and subcombinations with one another. The disclosed technology is not limited to any specific aspect or feature, or combination thereof, nor do the disclosed methods, apparatus, and systems require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may be rearranged or performed concurrently. Moreover, for the sake of simplicity, the attached figures may not show the various ways in which the disclosed methods, apparatus, and systems can be used in conjunction with other methods, apparatus, and systems. Additionally, the description sometimes uses terms like “determine,” “analyze” and “identify” to describe the disclosed technologies. These terms are high-level abstractions of the actual operations that are performed. The actual operations that correspond to these terms may vary depending on the particular implementation and are readily discernible by one of ordinary skill in the art.

As used in this application and in the claims, the singular forms “a,” “an” and “the” include the plural forms unless the context clearly dictates otherwise. Additionally, the term “includes” means “comprises.” Further, the term “coupled” means electrically or electromagnetically connected or linked and does not exclude the presence of intermediate elements between the coupled items. The phrase “and/or” means “and,” “or,” and “both.”

In at least some of the embodiments described below, when an operation is described as being performed on an electronic circuit design, this can mean that during a simulation of the design, the operation is simulated as being performed on the circuit described by the circuit design. For example, if a value is described as being “written” to the circuit or the circuit design, this can refer to the value being simulated as written to the circuit described by the design.

The disclosed embodiments can be implemented in a wide variety of environments. For example, any of the disclosed techniques can be implemented in software comprising computer-executable instructions stored on computer-readable media (e.g., one or more CDs, volatile memory components (such as DRAM or SRAM), or nonvolatile memory components (such as hard drives)). Such software can comprise, for example, electronic design automation (“EDA”) software (e.g., a logic simulator tool or a software debugger) used to diagnose test results captured during testing of one or more circuit designs (e.g., an application specific integrated circuit (“ASIC”), a programmable logic device (“PLD”) such as a field-programmable gate array (“FPGA”), or a system-on-a-chip (“SoC”) having digital, analog, or mixed-signal components thereon). This particular software implementation should not be construed as limiting in any way, however, as the principles disclosed herein are generally applicable to other software tools.

Such software can be executed on a single computer or on a networked computer (e.g., via the Internet, a wide-area network, a local-area network, a client-server network, or other such network). For clarity, only certain selected aspects of the software-based implementations are described. Other details that are well known in the art are omitted. For example, it should be understood that the disclosed technologies are not limited to any specific computer language, program, or computer. For the same reason, computer hardware is not described in further detail. For example, the disclosed embodiments can be implemented using a wide variety of commercially available computer systems and/or testing systems. Any of the disclosed methods can alternatively be implemented (partially or completely) in hardware (e.g., an ASIC, PLD, or SoC).

Further, diagnostic results (e.g., events simulated as occurring in an electronic circuit design, including values simulated as being stored in the design, as well as any intermediate diagnostic results) produced from any of the disclosed methods can be created, updated, or stored on computer-readable media (e.g., one or more CDs, volatile memory components (such as DRAM or SRAM), or nonvolatile memory components (such as hard drives)) using a variety of different data structures or formats. For example, a list of software instructions or memory values can be stored on computer readable-media. Such diagnostic results can be created or updated at a local computer or over a network (e.g., by a server computer). As used herein, the term “list” refers to a collection or arrangement of data that is usable by a computer system. A list can be, for example, a data structure or combination of data structures (such as a queue, stack, array, linked list, heap, or tree) that organizes data for better processing efficiency, or any other structured logical or physical representation of data in a computer system or computer-readable media (such as a table used in a relational database).

### Exemplary System and Method for Analyzing an Electronic Circuit Design

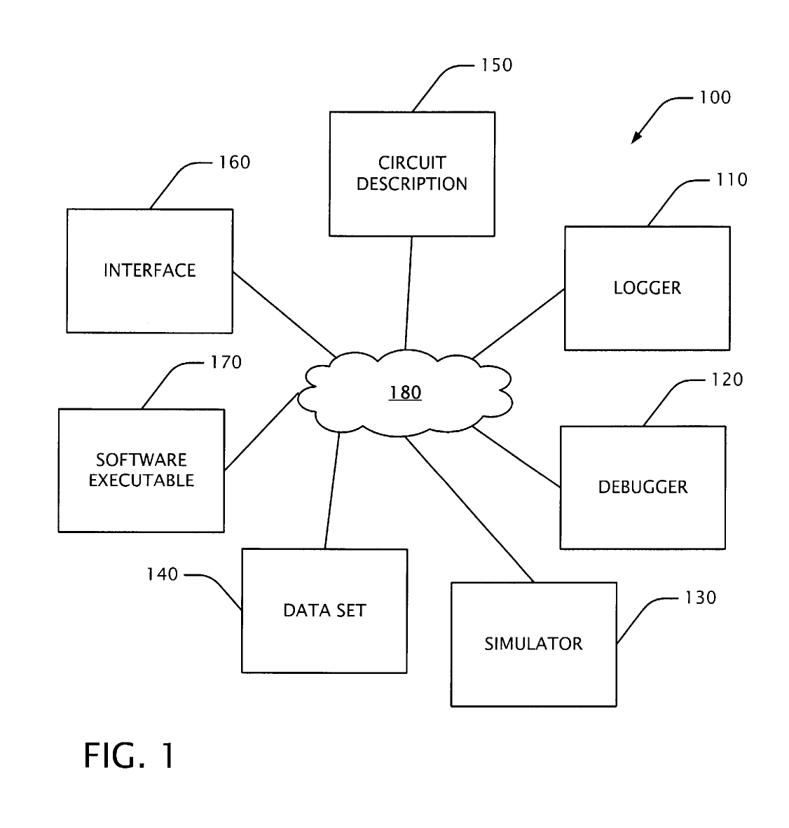

FIG. 1 is a block diagram of one embodiment of an exemplary system 100 for analyzing a circuit design. The system 100 comprises: a logger 110, which stores and/or displays recorded or stored outputs from a simulation of an electronic circuit design; and a debugger 120, which displays computer code and/or programming values (e.g., values simulated as being stored in storage elements, such as in registers and/or memory locations of the circuit design). In some embodiments, the logger 110 records or stores outputs from a simulator 130 (e.g., a logic simulator such as ModelSim® from Mentor Graphics Corp.). The system 100 can further comprise a data set 140, which generally describes changes made to values simulated as being stored in storage elements, such as in registers and/or memory locations in the circuit design, as explained in more detail below. A circuit description 150 of the electronic circuit design can be stored on one or more computer-readable media in a variety of formats, e.g., OASIS, GDSII, HDL, RTL or other formats. In some embodiments the system 100 can further comprise an interface layer 160. The interface layer 160 can interact with some or all of the components in the system 100, and can generally facilitate exchange of information among the components. The interface layer 160 can be implemented as part of one or more of the other components (e.g., the logger 110 or the debugger 120) or as a separate component. One or more components in the system 100 can be configured to be indifferent as to the existence of the interface layer 160. A software executable 170 comprises at least a portion of the software executed on the electronic circuit design to produce the data set 140. The degree of interaction among the components of the system 100 can vary according to the embodiment, and data hub 180 symbolizes this versatility.

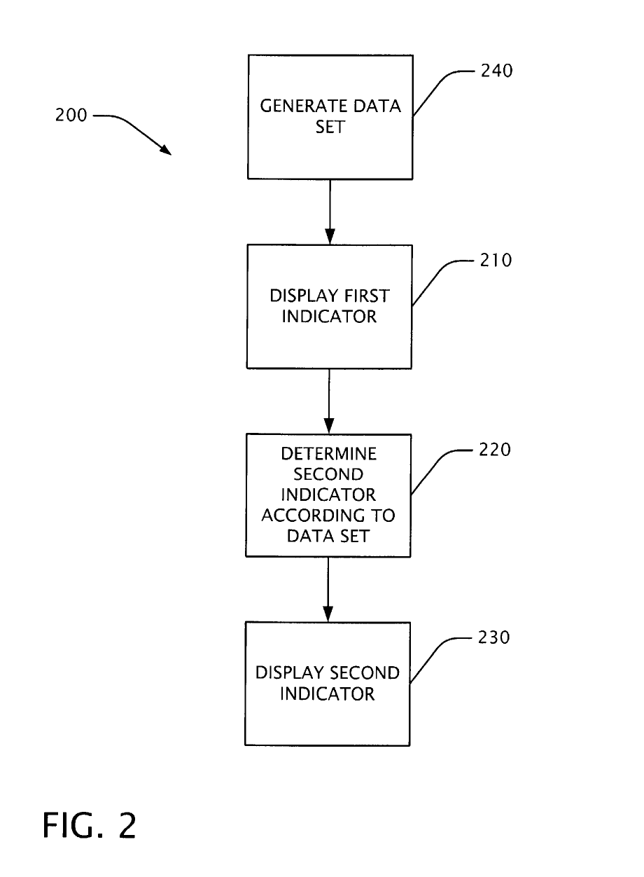

FIG. 2 shows a block diagram of one exemplary embodiment of a method 200 for displaying results of a simulation of an electronic circuit design. In method act 210, a “first indicator” is displayed, which can correspond to either: (1) information describing the state or status of the software executable 170 as simulated in the electronic circuit design (sometimes referred to herein as “status data” or “software status data”); or (2) one or more values corresponding to the results of the simulation. The status data for the software program can comprise, for example, software instructions (e.g., source code instructions, assembly code instructions and/or machine code instructions), register values, memory values, variable values, and/or other information that describes the state of the software executable 170 as simulated in the electronic circuit design. In some embodiments, the first indicator is provided as a result of user input. For example, a first indicator can result from: placing a cursor on one or more lines of software code in a debugger application window; stepping through a listing of software code in a debugger application window; or placing a cursor at one or more locations in a waveform viewer. In further embodiments such actions can be automated, e.g., using a script. In some embodiments, the values corresponding to the results of the simulation can take forms such as memory or register values, as well as waveforms or other graphical depictions of such values. In method act 220, a “second indicator” is determined according to a data set. The second indicator results from the first indicator and can be the other of the software status data or the one or more values corresponding to the results of the simulation. The second indicator can correspond at least in part to the first indicator. In method act 230, the second indicator is displayed and, in some embodiments, stored in one or more computer-readable media. In some embodiments, the method 200 further comprises generating a data set (method act 240), which is explained in more detail below.

Generally, the applications used in embodiments of method 200 for displaying the first and/or second indicators can be software applications useful for analyzing an electronic circuit design, including software for analyzing software instructions used in a simulation of the design. Example applications can include: a software debugger; a logic simulator (e.g., ModelSim®, CSim from Intel Corp., or VCS® from Synopsis, Inc.); and a waveform viewer (e.g., ModelSim®, Debussy® from Novis, Inc., or SimVision from Cadence, Inc.), for displaying simulation outputs as waveform and/or numerical values. In some embodiments, the applications operate as separate software applications, while in other embodiments the applications operate as one software application.

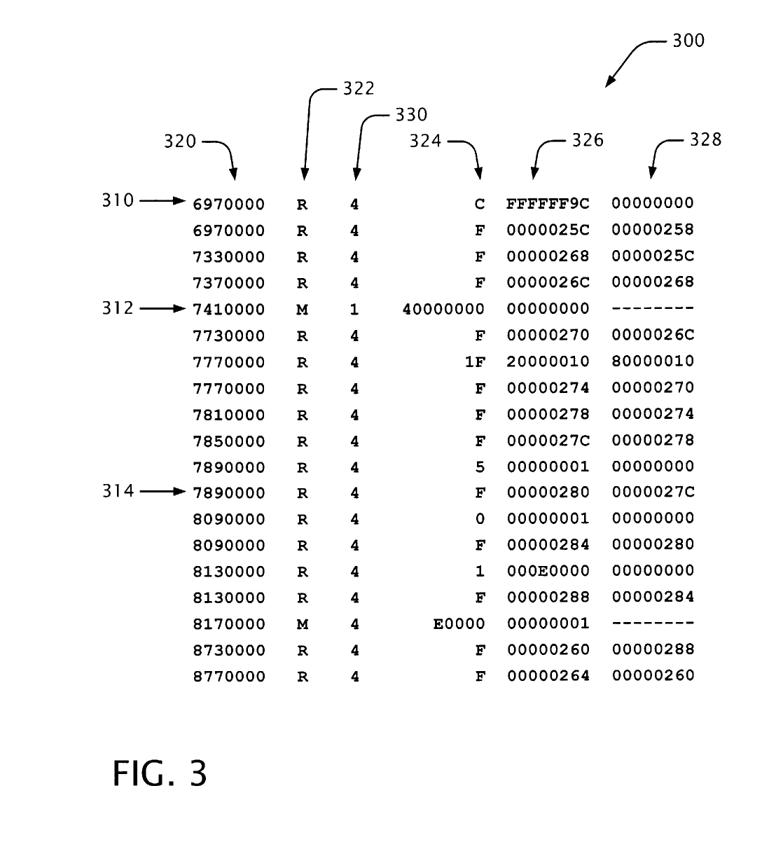

FIG. 3 shows a portion 300 of one exemplary embodiment of a data set. In some embodiments the data set can be generated (for example, as a log file) by a component (such as the logger 110) during or after the execution of the circuit design simulation and displayed or stored in one or more computer-readable media. In the depicted embodiment, information is stored in tuples (displayed in the depicted embodiment as rows 310, 312, 314) comprised of a plurality of data elements (displayed in the depicted embodiment in columns 320, 322, 324, 326, 328, 330). A tuple can contain information describing a simulated transaction in which a value is written to a storage location (e.g., a register location or a memory location described in the circuit design). In the depicted embodiment, elements in column 320 indicate times when the simulated transactions occurred. In some embodiments, the time can be a relative time, while in some embodiments the time is an absolute time. In the depicted embodiment, the time is expressed in picoseconds since the start of the simulation used to generate the data set. Elements shown in column 322 can indicate one or more destination types for the transactions. In the depicted embodiment, values in this column can indicate whether a transaction involves writing to a register location (as denoted by “R”) or to a memory location (as denoted by “M”). In further embodiments, elements such as those shown in the destination type column 322 can indicate that values can be simulated as being written to other storage locations such as: multiple memory spaces, e.g., tightly coupled memories (TCM) (often found in processors from ARM, Ltd.), scratchpad memories (often found in PowerPC processors from IBM, Inc.), or local memories (often found in processors from MIPS Technologies, Inc.); and additional register spaces, e.g., co-processor registers, memory management unit (MMU) registers, and cache control registers. Elements shown in column 324 can indicate one or more addresses to which the respective values in column 326 are simulated as being written. Addresses can include, e.g., register numbers (for register writes) and memory addresses (for memory writes).

Further data set embodiments can comprise some or all of the types of data shown in FIG. 3, as well as additional types of data. For example, the embodiment depicted in FIG. 3 further comprises a data element, shown in column 328, indicating a previously stored value for a register or memory location, e.g., a value stored in the address indicated in column 324 before it was overwritten by the value indicated in column 326. The depicted data set portion 300 can further comprise an element, shown here in a column 330, indicating a size (e.g., in bytes) of the data in column 326 that is being written to the destination specified in columns 322, 324.

The tuple shown as row 310 provides an example of data that can be stored in a data set. This data indicates that at a time 6970000, a value of FFFFFF9C, having a size of 4 bytes, was written to a register having an address C. Before this time, the value 00000000 was stored at this location. As another example, the data in row 312 describes a transaction at a time 7410000, in which a 1-byte value of 00 was written to a memory location at address 40000000. (In the depicted embodiment, some elements (e.g., elements shown in column 326) contain values comprising more characters than are necessary for describing a value. Further embodiments can be configured such that elements shown in one or more columns contain no more characters than necessary for describing a value.) The symbol “--------” appearing in column 328 for the tuple of row 312 indicates that, when the transaction described in the tuple of row 312 occurred, there was no prior value stored in the relevant location, e.g., the transaction described by the tuple of row 312 was the first time that the location was written to during the simulation.

In the depicted embodiment, register F is the program counter for the circuit design, and thus transactions modify values stored in this register relatively often (see, e.g., row 314).

Generally, the data set can be expressed and stored in a number of formats, including hexadecimal values, binary values, decimal values, text values and other formats. Some embodiments can express data in more than one format. In further embodiments at least some of the values are stored as absolute values, while in some embodiments at least some of the values are stored as difference values.

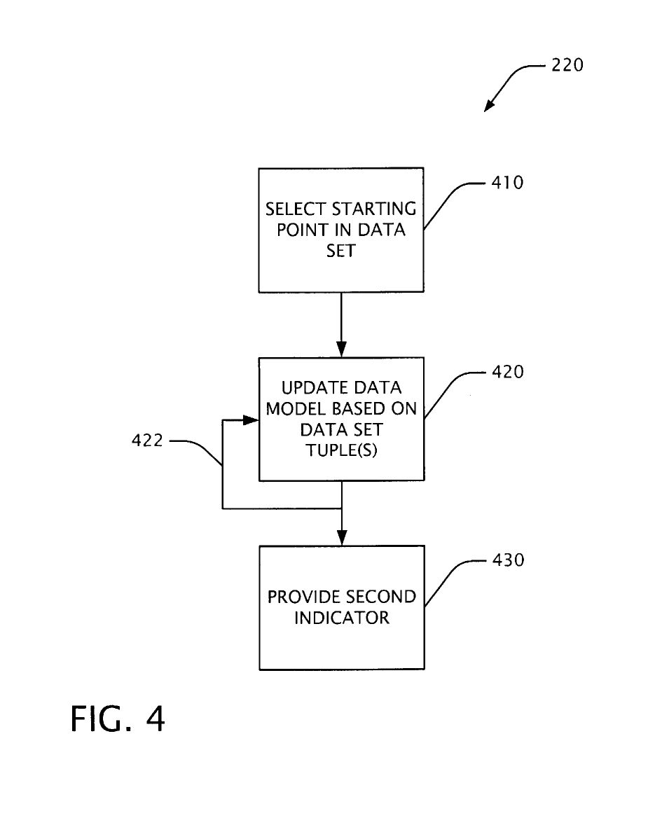

FIG. 4 is a block diagram of one exemplary embodiment of method act 220 from FIG. 2. In method act 410, a starting point in the data set is selected. Generally, the starting point (or “reference point”) reflects a time when some or all of the values stored in storage locations such as in registers and/or memory locations of the circuit described by the circuit description 150 are known. For example, in some embodiments the starting point can be selected to reflect a reset state, the beginning of a simulation, and/or a state when known values have been loaded into one or more registers and/or memory locations. In some cases (e.g., when the starting point is the beginning of a simulation), the starting point can be the beginning or near the beginning of the data set. In other cases, the starting point can be elsewhere in the data set. In method act 420, a data model (which can describe values simulated as being stored in the circuit design, e.g., in memory and/or register locations, and which can be part of the interface component 160) is updated based on information stored in one or more tuples (generally, one or more successive tuples) of a data set. As indicated by arrow 422, method act 420 can be repeated as necessary until the second indicator is determined. In method act 430, a second indicator is provided, which can comprise, for example, storing the second indicator in one or more computer-readable media and/or displaying the second indicator.

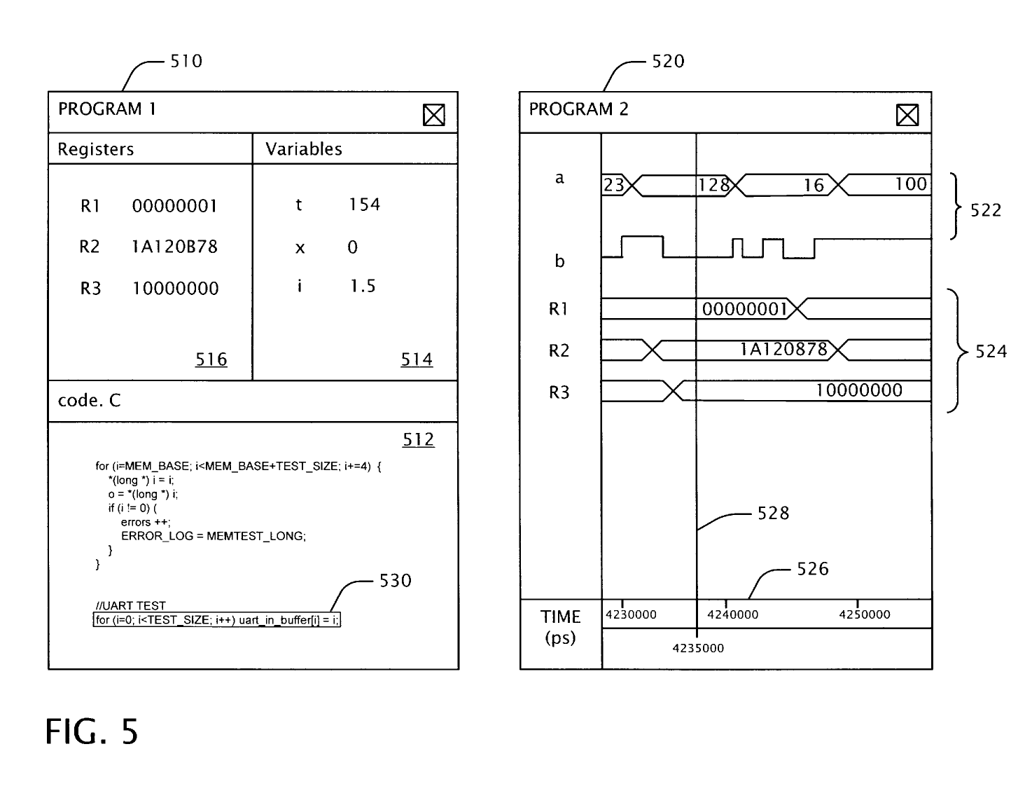

FIG. 5 shows embodiments of exemplary applications used in conjunction with embodiments described elsewhere in this application. In various embodiments, the applications can be presented with a number of user interfaces, though the applications in FIG. 5 use a window-based graphical user interface (GUI). A first application, which in some embodiments is a software debugger 120 or similar program, appears in a region such as a window 510. The window 510 can be broken into multiple regions such as windows, e.g., a source code window 512 (showing at least a portion of the code comprising the software executable 170), a variables watch window 514, and a registers watch window 516. A second application, which in some embodiments is a program that displays a waveform generated by a simulation, and can also display data related to the waveform (e.g., a logger 110), appears in window 520. In the depicted embodiment, the window 520 comprises variable waveforms 522 and register waveforms 524 presented along a time axis 526. In the depicted embodiment, the time axis 526 indicates the time (in ps) since the beginning of the simulation, but other forms of measurement can be used, such as a number of simulated clock cycles, for example. A cursor 528 can be placed at one or more points along the axis 526. In some embodiments, the cursor 528 can be used to visually correlate one or more values in the waveforms 522, 524 with the time axis 526 or with values in one or more other waveforms. For example, cursor 528 can be a line that intersects various waveforms and correlates these waveform values as the intersection of the cursor with a frame value on axis 526. In further embodiments, a second cursor 530 indicates one or more lines of code in the code window 512 corresponding to the values indicated by the cursor 528.

In some embodiments a user can utilize applications such as those shown in FIG. 5 to examine simulation results of an electronic circuit design. In one example, the user sets the cursor 528 at a desired location in the window 520. This can correspond to displaying a first indicator (e.g., as in method act 210 of method 200). For the purposes of this example, the first indicator is a time value (4235000) identifying the amount of time since the beginning of the simulation. This time value is associated with an entry in the data set 140 (e.g., as in method act 220 of method 200). In some embodiments, this can be done by identifying a tuple in the data set 140 which most closely corresponds to the time value provided as the first indicator. A starting point in the data set is selected (e.g., as in method act 410), which for the purposes of this example is assumed to be the beginning of the data set 140, corresponding to the beginning of the simulation described by the data set 140. To determine the second indicator, entries from the data set 140 can be used to recreate the values simulated as being written to registers and/or memories of the electronic circuit design. That is, a model of registers and memories of the circuit design can be created and/or modified according to the transactions described in the data set 140 (e.g., as in method acts 420, 422). Once the model has been modified using data set transactions through the time identified by the first indicator (or, in some embodiments, shortly before or after this time), a second indicator can be provided to the application in the window 510 from the model (e.g., as in method act 430).

In the present example, the watch windows 514, 516 can be updated with values related to the second indicator. The source code window 512 can also be updated to display a portion of code (e.g., in box 530) that was simulated as being executed by the electronic circuit design at the time indicated by the cursor 528 in the window 520. In some embodiments, values for registers and/or variables can be determined by reading values directly from the data model, while a portion of source code can be associated with the indicated time by examining the portion of the data model corresponding to a program counter or similar device. Generally, a program counter value can be mapped to a source code instruction through a lower-level instruction, e.g., an assembly code instruction. In some embodiments, the above acts are repeated as a user drags one of the cursors 528, 530 over multiple values in the window 520 or over lines of code in the window 512. In further embodiments, the second indicator comprises one or more values in one or more watch windows 514, 516 (e.g., one or more variable or register values).

In the present example, a data model was created by starting at the beginning of the data set 140 and proceeding “forward” (i.e., chronologically) in the file until the data set tuple associated with the first indicator was reached. However, in some embodiments, the data model can be modified from a known state other than from the beginning of the simulation. In further embodiments, the data model can be modified by proceeding chronologically “backward” in the data set 140. In such embodiments, a transaction to the data model can be “undone” by writing to the register or memory location a prior value associated with the transaction, such as a value stored in column 328 of the data set portion 300. Such embodiments can be useful in cases where, for example, a data model with known values already exists and the first indicator requires determining values for an earlier or later time, such that modifying the data model from its current state would involve fewer transactions than modifying the model from the beginning of the simulation.

As can be seen from the foregoing and following examples, embodiments of the systems and methods described herein can allow a user to more easily and efficiently examine the outputs of an electronic circuit design simulation. As described above, a user can select a time point or points in a description of simulation outputs, which can cause corresponding register, memory and other values to be determined.

In a further example, a first indicator is provided when a user selects one or more lines of code from a listing such as that appearing in the window 512. In this embodiment, the second indicator is determined (method act 220) by identifying a program counter value corresponding to the selected code line(s), and using one or more data set tuples, as is similarly described above. In some embodiments a particular line of code can correspond to more than one tuple in the data set (e.g., if the line of code is in a loop). Accordingly, this feature can be configured to be made available for one or more portions of the code for which a particular data set tuple can be determined.

Features often found in debugger applications, such as breakpoints, stepping into, stepping out, etc., can be used with technologies described herein. Thus, some embodiments can be configured, for example, to allow a user to step through a software program while observing changes in memory, registers and/or other hardware structures of the circuit design.

Other user interface features can be used with embodiments of the disclosed technologies. For example, in some embodiments a mouse cursor or other cursor can be placed over or near a line of code in a listing of code from the software executable. Using the systems and techniques described herein, in response to the placement of the cursor, values for one or more registers and/or memory locations can be displayed. In some embodiments, these one or more values can be displayed near the cursor as cursor-responsive supplemental information, such as a “tooltip.”

### Exemplary Computer Networks

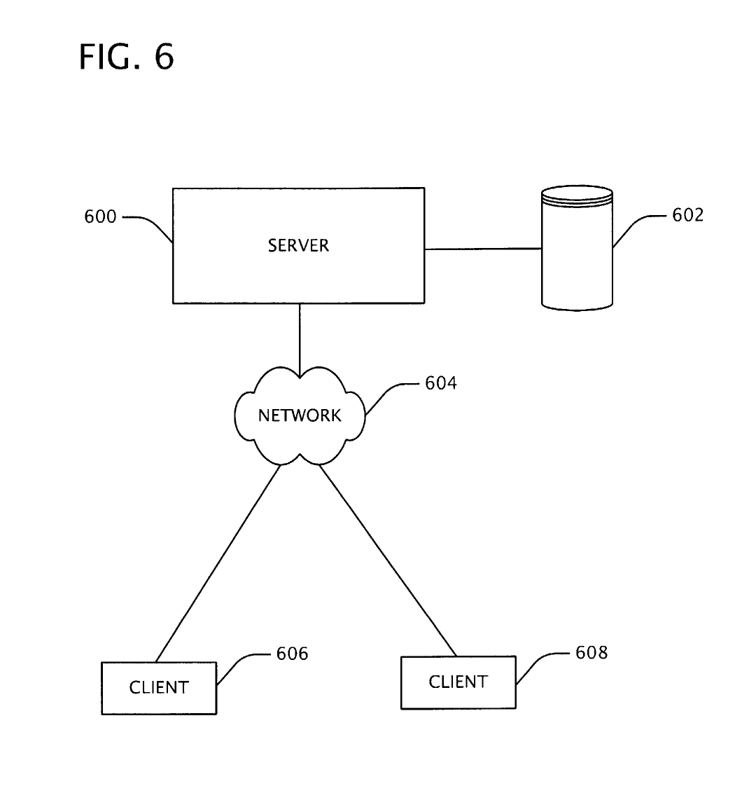

Any of the aspects of the technologies described above can be performed using a distributed computer network. FIG. 6 shows one such exemplary network. A server computer 600 can have an associated storage device 602 (internal or external to the server computer). For example, the server computer 600 can be configured to display circuit simulation results according to any of the disclosed embodiments (e.g., as part of an EDA software tool, such as a logic simulator or a software debugger tool). The server computer 600 can be coupled to a network, shown generally at 604, which can comprise, for example, a wide-area network, a local-area network, a client-server network, the Internet, or other such network. One or more client computers, such as those shown at 606, 608, can be coupled to the network 604 using a network protocol.

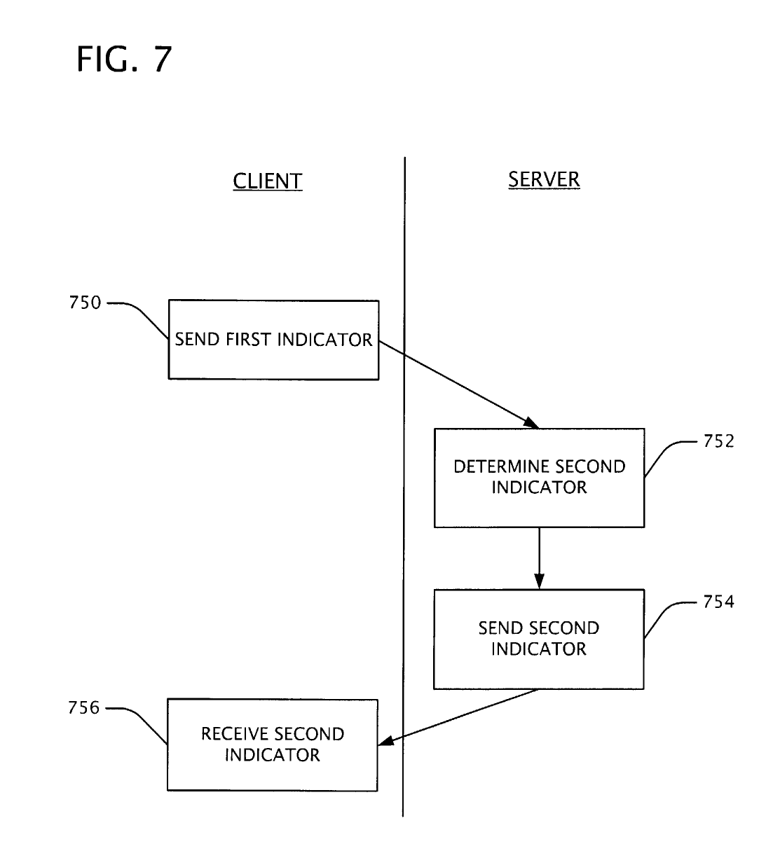

FIG. 7 shows one exemplary manner in which the distributed network shown in FIG. 6 may operate to display circuit simulation results. In particular, a first indicator can be used to determine a second indicator according to any of the embodiments disclosed herein using a remote server computer, such as the server computer 600 shown in FIG. 6. In method act 750, for example, the client computer sends a first indicator to the server computer. In method act 752, a second indicator is determined by the server computer. In method act 754, the server computer sends the second indicator to the client computer, which receives the second indicator in method act 756.

It should be apparent that the example shown in FIG. 7 is not the only way to analyze simulation results according to the disclosed technology. For instance, a first indicator can be stored on a computer-readable medium that is not on a network and that is sent separately to the server (e.g., on a CD-ROM or other computer-readable medium). Moreover, the server computer may perform only a portion of the determination procedure.

Having shown and described the principles of the illustrated embodiments, it will be apparent to those skilled in the art that the embodiments can be modified in arrangement and detail without departing from such principles. For example, any of the embodiments described herein need not be performed over a distributed computer network. In view of the many possible embodiments, it will be recognized that the illustrated embodiments include only examples and should not be taken as a limitation on the scope of the invention. Rather, the invention is defined by the following claims and their equivalents. We therefore claim as the invention all such embodiments that come within the scope of these claims and their equivalents.

We claim:

1. One or more computer-readable media comprising instructions for causing a computer to perform a method of displaying information about a simulation of an electronic circuit design, wherein the simulation simulates a software program being executed by the electronic circuit design and generates simulation results, the method comprising:
displaying, as a first indicator, either information describing a simulated status of the software program in the electronic circuit design or the simulation results;
determining, according to a data set describing a plurality of values simulated as being stored in the electronic circuit design during the simulation, a corresponding other of the information describing the simulated status of the software program in the electronic circuit design or the simulation results; and
displaying, as a second indicator, the corresponding other of the information describing the simulated status of the software program in the electronic circuit design or the simulation results.

2. The one or more computer-readable media of claim 1, wherein the information describing the simulated status of the software program in the electronic circuit design is displayed by a software debugger application.

3. The one or more computer-readable media of claim 1, wherein the information describing the simulated status of the software program in the electronic circuit design comprises one or more of the plurality of software instructions designed for execution on the electronic circuit design.

4. The one or more computer-readable media of claim 3, wherein the first indicator denotes at least one of the software instructions shown in a listing of the software instructions in a software debugger application, wherein the second indicator denotes a portion of a waveform shown in a waveform viewer, and wherein the second indicator describes one or more values simulated as being stored in the circuit design at an approximate time when the at least one of the software instructions is simulated as being executed.

5. The one or more computer-readable media of claim 4, wherein the first indicator is displayed as a result of stepping, in the software debugger application, from a first portion of the software instructions to a second portion of the software instructions.

6. The one or more computer-readable media of claim 1, wherein the information describing the simulated status of the software program in the electronic circuit design comprises one or more register values.

7. The one or more computer-readable media of claim 1, wherein displaying the simulation results comprises displaying at least a portion of the simulation results as a waveform.

8. The one or more computer-readable media of claim 1, wherein the data set describes data simulated as being written to registers or memory addresses described in the electronic circuit design.

9. The one or more computer-readable media of claim 1, wherein the second indicator comprises cursor-responsive supplemental information.

10. The one or more computer-readable media of claim 1, wherein the determining the corresponding other of the information describing the simulated status of the software program in the electronic circuit design or the simulation results further comprises determining effects of one or more simulated write operations on register or memory addresses described in the circuit design.

11. The one or more computer-readable media of claim 1, wherein the determining the corresponding other of the information describing the simulated status of the software program in the electronic circuit design or the simulation results comprises reading data set data between a reference point and a point in the data set associated with the first indicator.

12. The one or more computer-readable media of claim 11, wherein the reference point corresponds to a first point in time in the data set data, wherein the point in the data set data associated with the first indicator corresponds to a second point in time in the data set data, and wherein the first point in time is before the second point in time.

13. The one or more computer-readable media of claim 11, wherein the reference point corresponds to a first point in time in the data set data, wherein the point in the data set data associated with the first indicator corresponds to a second point in time in the data set data, and wherein the first point in time is after the second point in time.

14. A user interface for displaying information about a simulation of an electronic circuit design on a display, the user interface comprising:
a first display region displaying one or more software status data for a software program whose execution in the circuit design was at least partially simulated during the simulation;
a second display region displaying the simulation results;
a first cursor in a first position in the first display region indicating a first portion of the software status data; and
a second cursor in a second position in the second display region that indicates a simulation result corresponding to the first portion of the software status data, wherein displaying the first cursor in a first alternate position indicating a second portion of the software status data results in displaying the second cursor in a second alternate position indicating a simulation result corresponding to the second portion of the software status data, or wherein displaying the second cursor in the second alternate position results in displaying the first cursor in the first alternate position.

15. The user interface of claim 14, wherein the software status data comprises one or more software instructions.

16. A system for displaying simulation results of a simulation of an electronic design, the system comprising:
a first software component configured to display one or more status data for a software program executed as part of the simulation to produce the simulation results;
a second software component for displaying at least a portion of the simulation results;
a third software component configured to examine, in response to selecting either at least one of the status data for the software program or the at least a portion of the simulation results, a list of values simulated as being stored in the circuit design during the simulation; and
a fourth software component configured to display, based on the examined list of values, the at least one of the status data for the software program if the at least a portion of the simulation results is selected, or to display, based on the examined list of values, the at least a portion of the simulation results if the at least one of the status data for the software program is selected.

17. The system of claim 16, wherein the first software component is a software debugger application and the second component is a waveform display application.

18. The system of claim 16, wherein the selecting either at least one of the status data for the software program or the at least a portion of the simulation results occurs in response to one or more of user input, a script, or a software debugger application.

19. The system of claim 16, further comprising a fifth software component for generating the list of values.

20. The system of claim 16, wherein the status data for the software program comprises one or more software instructions.

21. A method of displaying results of a simulation of an electronic circuit design, the design being configured to store a first set of values that are provided on one or more output pins of the design and a second set of values that are not provided on the one or more output pins of the design, the simulation being of a software program being executed on the design, the method comprising:
reading from one or more computer-readable media a description of a plurality of transactions simulated as occurring in the electronic circuit design during the simulation, the transactions affecting values in the first and second sets of values;
determining, according to the electronic circuit design, the software program, and the description of a plurality of transactions, one or more values of the second set of values; and
storing the one or more values of the second set of values in one or more computer-readable media.

22. The method of claim 21, further comprising generating the description of a plurality of transactions.

23. One or more computer-readable media storing a data structure describing results of a simulation of an electronic circuit design, wherein the data structure comprises:
a time indicator for the simulation;
a write address indicator identifying one or more data storage locations described in the circuit design; and
a write value indicator identifying one or more values simulated as being written to the one or more storage locations described in the circuit design.

24. The one or more computer-readable media of claim 23, wherein the data structure further comprises an indication of one or more values simulated as being overwritten by at least some of the values simulated as being stored in the one or more storage locations.

25. The one or more computer-readable media of claim 23, wherein the data structure further comprises an identification of at least one of a register or a memory location.
